(19) United States
(12) Patent Application Publication
(10) Pub. No.: US 2025/0316732 A1
(43) Pub. Date: Oct. 9, 2025

(54) FUEL CELL SYSTEM WITH RADIATOR AND CONTROL METHOD THEREOF

(71) Applicant: Infintium Fuel Cell Systems, Inc., Greenville, SC (US)

(72) Inventor: Seneca A. Schepmann, Greenville, SC (US)

(21) Appl. No.: 19/169,985

(22) Filed: Apr. 3, 2025

Related U.S. Application Data
(60) Provisional application No. 63/631,422, filed on Apr. 8, 2024.

(51) Int. Cl. H01M 8/04746; H01M 8/04007; H01M 8/04014; H01M 8/04029; H01M 8/04302; H01M 8/0432; H01M 8/0444; H01M 8/04492

(52) U.S. Cl. CPC H01M 8/04768; H01M 8/04014; H01M 8/04029; H01M 8/04067; H01M 8/04302; H01M 8/0432; H01M 8/04462; H01M 8/0447; H01M 8/04492

(57) ABSTRACT

A radiator of a fuel cell system may include plurality of fans mounted on a surface of the radiator, and an exhaust inlet through which fuel cell stack exhaust of the fuel cell system passes through the radiator. A first fan of the radiator may be configured for discharge of fuel cell stack exhaust, and operation of the first fan is controllable based on at least one parameter associated with the discharge of the fuel cell stack exhaust. A second fan of the radiator may be configured for cooling, and operation of the second fan is controllable based on at least a temperature of the fuel cell system. A controller may be configured to control the operation of the first fan based on whether the at least one parameter satisfies an exhaust discharging criteria.

### CROSS-REFERENCE TO RELATED APPLICATIONS

This patent application claims priority to U.S. Provisional Application No. 63/631,422, filed on Apr. 8, 2024 and entitled “Radiator for Fuel Cell System and Control Method Thereof,” which is incorporated herein by reference as if reproduced in its entirety.

### TECHNICAL FIELD

The present disclosure relates generally to the field of fuel cell systems, and in particular embodiments, to techniques and mechanisms of a fuel cell system with a radiator and control methods thereof.

### BACKGROUND

Fuel cell systems are power supply systems designed to generate electricity through a chemical reaction between a fuel and an oxidizing agent. As an example, a fuel cell system may use hydrogen as fuel and oxygen from the air as oxidizer, producing only water and heat as byproducts. Compared to traditional combustion-based power generation technologies, fuel cell systems generate electricity with lower emissions. Compared to batteries or combustion engines, fuel cells are more efficient, and eliminate the need to change, charge or manage batteries, which saves labor and space. Other advantages of fuel cell systems include higher energy concentration, extended lifespan, rapid refueling/recharging capabilities, environmentally friendly operation, enhanced efficiency, scalability, and more. Fuel cell systems offer a clean, efficient, and versatile solution for a wide range of power generation applications, e.g., for providing backup power, providing power supply in remote locations, such as spacecraft, remote weather stations, large parks, communications centers, rural locations, and so on, and powering fuel cell vehicles, such as forklifts, automobiles, buses, trains, boats, motorcycles, and so on.

It is thus desirable to develop techniques and mechanisms to improve performance of fuel cell systems in various aspects, and to facilitate utilization of fuel cell systems.

### SUMMARY

Technical advantages are generally achieved by embodiments of this disclosure which describe a fuel cell system with a radiator and control methods thereof.

In accordance with one aspect of the present disclosure, a radiator of a fuel cell system is provided, which includes: an exhaust inlet through which fuel cell stack exhaust of the fuel cell system passes through the radiator, wherein the exhaust inlet is disposed on a surface of the radiator; a first fan mounted on the surface of the radiator, wherein operation of the first fan is controllable based on at least one parameter associated with discharge of the fuel cell stack exhaust; and a second fan mounted on the surface of the radiator, wherein operation of the second fan is controllable based on at least a temperature of the fuel cell system.

In accordance with another aspect of the present disclosure, a fuel cell system is provided, which includes a radiator comprising: an exhaust inlet through which fuel cell stack exhaust of the fuel cell system passes through the radiator, wherein the exhaust inlet is disposed on a surface of the radiator; a first fan and a second fan mounted on the surface of the radiator, wherein the first fan is configured to operate for discharge of the fuel cell stack exhaust, and the second fan is configured to operate for cooling of the fuel cell system. The fuel cell system further includes a controller coupled to the first fan and the second fan, wherein the controller is configured to: control operation of the first fan based on at least one parameter associated with the discharge of the fuel cell stack exhaust; and control operation of the second fan based on at least a temperature of the fuel cell.

In accordance with another aspect of the present disclosure, a method is provided that includes: detecting, at a controller of a fuel cell system, that at least one parameter associated with discharge of fuel cell stack exhaust of the fuel cell system satisfies an exhaust discharging criteria, wherein the fuel cell system comprises a radiator having a plurality of fans, and the plurality of fans comprises a first fan configured to operate for exhaust discharging and a second fan configured to operate for cooling; and controlling, by the controller of the fuel cell system, to turn on or off the first fan of the plurality of fans.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an example fuel cell system in a perspective view according to embodiments of the present disclosure;

FIG. 2 is a schematic block diagram of the fuel cell power supply system in FIG. 1;

FIG. 3 is a diagram of the fuel cell system in FIG. 1 in a front/top/left side perspective view, highlighting a radiator;

FIG. 4 is a diagram of an example radiator used in a fuel cell system according to a conventional technology;

FIG. 5 is a diagram of an example radiator of a fuel cell system according to embodiments of the present disclosure;

FIG. 6 is a flowchart of an example method of controlling a radiator for cooling according to embodiments of the present disclosure;

FIG. 7 is a flowchart of an example method of controlling a radiator for exhaust discharge according to embodiments of the present disclosure;

FIG. 8 is a flowchart of another example method of controlling a radiator for exhaust discharge according to embodiments of the present disclosure;

FIG. 9 is a block diagram of an example fuel cell system according to embodiments of present disclosure;

FIG. 10 is a block diagram of another example fuel cell system according to embodiments of present disclosure; and

FIG. 11 is a flowchart of an example method of controlling a radiator according to embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood within the scope of this disclosure. It is therefore intended that the appended claims encompass any such modifications or embodiments.

In addition, terms “first”, “second”, and so on, are only used to distinguish one feature (e.g., one entity or operation) from another feature (e.g., another entity or operation), and should not be interpreted as indicating or implying a relative importance, an order, or a quantity of indicated features. A feature limited with “first” or “second” may explicitly indicate or implicitly include one or more of the feature.

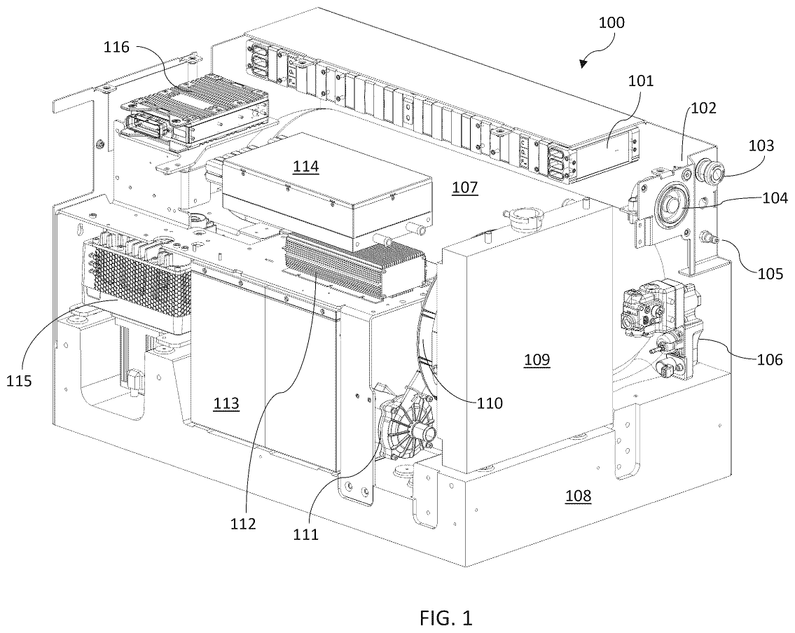

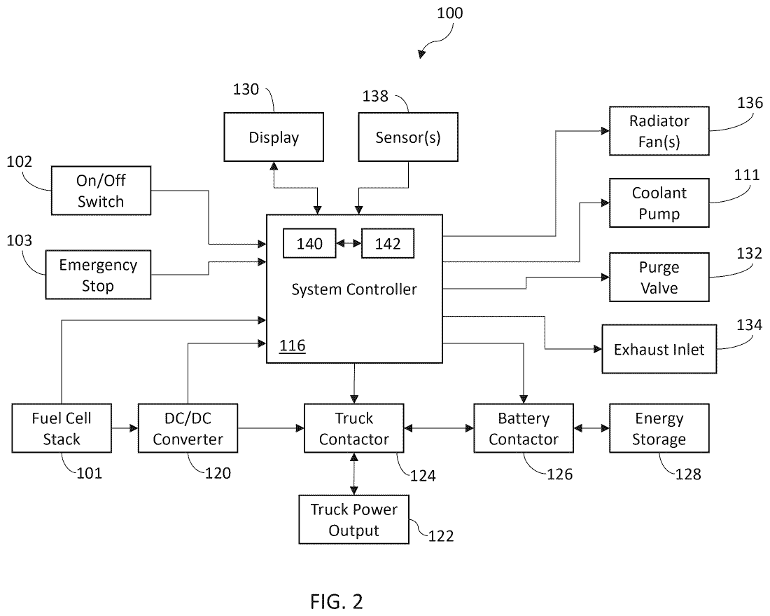

The following is provided with reference to FIG. 1 and FIG. 2. FIG. 1 is a diagram of an example fuel cell power supply system 100 in a perspective view according to embodiments of the present disclosure. FIG. 2 is a schematic block diagram of the example fuel cell power supply system 100 in FIG. 1, which shows an example implementation of the fuel cell power supply system. In this example, the fuel cell power supply system 100 uses hydrogen as fuel. However, hydrogen is merely use as an example for illustration purpose. Any other fuel applicable for fuel cell power systems may also be used. The terms of “fuel cell power supply system”, “fuel cell system” and “system” are used interchangeably in the present disclosure.

The fuel cell power supply system 100 as shown in FIG. 1 may include a fuel cell stack 101, an on/off switch 102, an emergency stop switch 103, a fill port 104, a drain port 105, a pressure regulator 106, a fuel tank 107, a system base frame 108, radiator assembly 109, a radiator fan 110, a coolant pump 111, a low power DC/DC converter 112, a battery 113, a high power DC/DC converter 114, an air compressor 115, and a system controller 116. The fuel cell system 100 may further include a truck power output 122, a truck contactor 124, a battery contactor 126, an energy storage device 128, a display 130, a purge valve 132, and an exhaust inlet 134, which are shown in FIG. 2.

Components of the fuel cell system 100 in this example are mainly arranged on or above the system base frame 108 in a system housing (not shown). The fuel cell stack 101 may be arranged close to a rear plate of the fuel cell system 100. As an example, the fuel cell stack 101 may be mounted on the rear plate. The rear plate may be part of the system housing. The fuel cell stack 101 may include one or more fuel cells, which may be combined in series into a fuel cell stack (stacked on top of each other) as typically used. A fuel cell is an electrochemical cell that converts the chemical energy of a fuel (e.g., hydrogen) and an oxidizing agent (e.g., oxygen) into electricity. As well known, a fuel cell typically includes an anode, cathode, and an electrolyte membrane. In operation, hydrogen is passed through the anode and oxygen is passed through the cathode. At the anode, a catalyst splits the hydrogen molecules into electrons and protons. The protons pass through the porous electrolyte membrane, while the electrons are passed through a circuit, generating an electric current. At the cathode, the protons, electrons, and oxygen combine to produce water and heat. A typical fuel cell stack may include hundreds of fuel cells. The amount of power produced by a fuel cell may depend upon various factors, such as the fuel cell type, the fuel cell size, the temperature at which it operates, the pressure of the gases supplied to the fuel cells, and so on.

The on/off switch 102 is used to turn on or off the fuel cell system 100. The emergency stop switch 103 is configured to stop operation of the fuel cell system 100 immediately in case of emergency, e.g., by cutting off the supply of the fuel.

The fuel (i.e., hydrogen) of the fuel cell system 100 is stored in the fuel tank 107. The fuel tank 107 may be arranged below the fuel cell stack 101. Hydrogen may be filled into the fuel tank 107 through the fill port 104. Fuel exhaust may be discharged through the drain port 105. The fuel exhaust may primarily include water and non-reactive components, such as traces of unreacted hydrogen, and possible impurities entering the fuel. The purge valve 132 (not shown in FIG. 1) will temporarily be opened during purge of the fuel cell stack 101 for discharging the fuel exhaust. Fuel stored in the fuel tank 107 is maintained at a certain pressure level, which may be adjusted by the pressure regulator 106.

The radiator assembly 109 is configured to manage the temperature of the fuel cell system 100 by dissipating excess heat generated during the electrochemical reactions that occur within the fuel cell stack 101. The radiator assembly 109 may include cooling components such as the radiator fan 110 for dissipating heat and the coolant pump 111 for pumping coolant. Hot/warm exhaust air from the fuel cell stack 101, and/or the fuel exhaust discharged from the fuel cell stack 101 (e.g., through the drain port 105) may enter the exhaust inlet 134 at the radiator assembly 109, be cooled down and exhausted through the radiator assembly 109, or to be re-circulated back to the fuel cell stack 101.

The amount of air available for the electrochemical reaction at the fuel cell stack 101 affects the performance of the fuel cell system 100. Fuel cell performance improves as the pressure of the reactant gases increases. The air compressor 115 is used to push air into the fuel cell stack 101 such that the air is provided to the fuel cell stack 101 at a desired flow rate. As an example, the air compressor 115 may raise the pressure of the incoming air of the fuel cell stack 101 to about 1.1˜3 times the ambient atmospheric pressure of the fuel cell stack 101.

The fuel cell stack 101 is coupled to a DC/DC converter 120 including the low power DC/DC converter 112 and the high power DC/DC converter 114. Fuel cells produce electricity in the form of direct current (DC). The electric power generated by the fuel cell stack 101 may be converted to different levels of DC power to match various load requirements by the DC/DC converter 120, e.g., to low DC power and high DC power by the low power DC/DC converter 112 and the high power DC/DC converter 114, respectively. The output of the DC/DC converter 120 may be a current or voltage. As an example, the DC/DC converter 120 may be configured to convert a DC voltage output by the fuel cell stack 101 to desired voltage(s). The fuel cell system 100 may include various numbers of DC/DC converters depending on the designs and applications of the fuel cell system 100.

The DCDC converter 120 may include a communication module, an input voltage measurement module, an input current measurement module, an output voltage measurement module, and/or an output current measurement module. In some embodiments, the DCDC converter 120 may control, according to the communication data of the communication module, specific numerical values of the output current and voltage, and output, through the communication module, data such as input voltages, input currents, output voltages, output currents, etc. The state data of the DCDC converter 120 may include DCDC input currents, and/or DCDC input voltages.

The DC/DC converter 120 may be connected to the truck power output 122 through the truck contactor 124. The truck contactor 124 may be a normal open type high-current contactor. The fuel cell system 100 supplies the electric energy generated by the fuel cell stack 101 to external devices/apparatus (referred to as external power receivers thereafter) through the truck power output 122.

The DC/DC converter 120 may also be connected to the energy storage device 128 through the truck contactor 124 and the battery contactor 126. The electric energy generated by the fuel cell stack 101 may be stored in the energy storage device 128, e.g., the battery 113. The stored energy in the energy storage device 128 may also be supplied to the external power receivers through the battery contactor 126, the truck contactor 124 and the truck power output 122.

The truck power output 122 can also accept regenerative charging current back through the truck contactor 124, the battery contactor 126 and into the energy storage 128. In this way, the truck contactor 124 and battery contactor 126 are capable of carrying bidirectional current into/out of the energy storage 128.

The system controller 116 is configured to manage and control operation of the fuel cell system 100. The system controller 116 may include one or more processors 140, such as microprocessors or microcontrollers, which are appropriately configured to carry out fuel cell system operations. The system controller 116 may further include a computer-readable storage device 142 storing computer-readable instructions, which may be executed by the one or more processors 140 of the system controller 116 for carrying out the fuel cell system operations. The computer-readable storage device 142 may include any non-transitory mechanism for storing information in a form readable by a machine (e.g., a computer, a processor). For example, a computer-readable storage device may include read-only memory (ROM), random-access memory (RAM), magnetic disk storage media, optical storage media, flash-memory devices, solid state storage media, and other storage devices and media.

The system controller 116 may be a controller with an integrated design, which may be a scattered fuel cell controller, a whole vehicle controller, or a battery energy management system. The system controller 116 may include an energy management unit, a fuel cell control unit, an energy storage device monitoring unit, a hydrogen safety monitoring unit, a system failure monitoring unit and/or a startup control unit.

As shown in FIG. 2, the system controller 116 may be connected to various components of the fuel cell system 100, such as the on/off switch 102, the emergency stop 103, the fuel cell stack 101, the DC/DC converter 120, radiator fan(s) 136 such as the radiator fan 110, the coolant pump 111, the purge valve 132, the exhaust inlet 134, the truck power output 124 through the truck contactor 124, and the energy storage 128 through the battery contactor 126.

As an example, when the on/off switch 102 is switched off, the system controller 116 may receive a signal indicating the switching off of the on/off switch 102, and control to stop operations of the fuel cell system 100, e.g., cutting off the fuel supply to the fuel cell stack 101, turning off the radiator fan(s) 136, and so on. As another example, the system controller 116 may control the power of the DC/DC converter 120 to ensure the power at the truck power output 122 and storing excess energy in the energy storage device 128. As yet another example, the system controller 116 may control to close and open the purge value 132 to discharge fuel exhaust.

The system controller 116 may be connected to the display 130, through which users/operators may interact with the fuel cell system 100. For example, a user may enter instructions through the display 130 and/or set parameter(s) for operations of the fuel cell system 100. A user may monitor operation status or parameters/information displayed on the display 130. The display 130 may be integrated with the system controller 116.

The system controller 116 may be connected to one or more sensors 138. The sensor(s) 138 may include various devices for detecting/sensing/measuring parameters of the fuel cell system 100, such as thermometer(s), timer(s), gas concentration sensor(s)/meter(s), moisture meter(s), and so on. The sensor(s) 138 may be positioned at various location depending on their purposes.

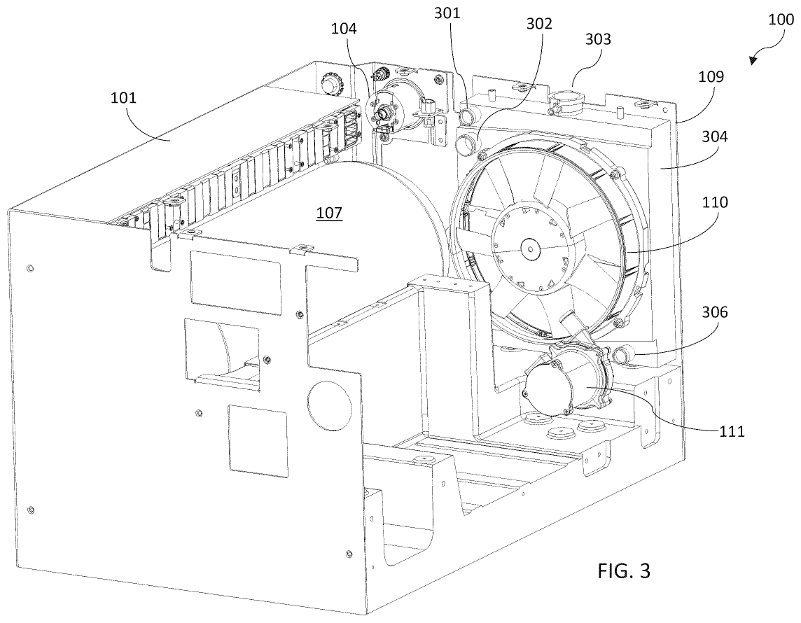

FIG. 3 is a diagram of the example fuel cell power supply system 100 in a front/top/left side perspective view according to embodiments of the present disclosure, with some components removed exposing the radiator assembly 109 from the left side of the fuel cell system 100. The radiator assembly 109 may also be referred to as a radiator or a radiator system. As used herein, the terms “radiator assembly”, “radiator” and “radiator system” are used interchangeably.

The radiator assembly 109 is configured to manage the temperature of the fuel cell system 100 by dissipating excess heat generated during the electrochemical reactions that occur within the fuel cell stack 101. During the electrochemical process within the fuel cell stack 101, heat is generated as a byproduct. Excessive heat can negatively impact the performance and lifespan of the fuel cell components. The radiator assembly helps regulate the temperature of the fuel cell system 100.

Generally, a radiator may provide functions including radiator fin(s) for air to water heat exchange, radiator fan(s), coolant in/out hose(s), and coolant fill and reservoir. A radiator may further have provisions for a second cooling loop (e.g., for transmission oil to coolant heat exchange, or oil to air heat exchange). A radiator may also include mounting provisions for a secondary heat exchanger used as a refrigerant loop, similar to that in an automotive air conditioning (AC) system.

In this example, the radiator assembly 109 includes a radiator coolant inlet 301, a radiator exhaust inlet 302, a radiator coolant fill port 303, a radiator core 304, the radiator fan 110, and a radiator coolant outlet 306.

The fuel cell system 100 may include a cooling channel/loop (not shown) passing through the fuel cell stack 101, and the radiator assembly through the radiator coolant inlet 301 and the radiator coolant outlet 306. The cooling channel may be in the form of tubes, pipes, hoses, and so on. Coolant fluid may be filled in the cooling channel through the radiator coolant fill port 303, and circulated in the cooling channel by the coolant pump 111. The radiator core 304 includes a portion of the cooling channel, e.g., a series of thin tubes, and fins designed to maximize the surface area of the radiator assembly, allowing for efficient heat exchange between the coolant and surrounding air. The radiator core 304 is connected to the radiator coolant outlet 306 and the radiator coolant inlet 301. The coolant exits the radiator assembly 109 (i.e., the radiator core 304) from the radiator coolant outlet 306, circulates through the fuel cell stack 101 absorbing heat therefrom, and circulates back to the radiator assembly 109 (i.e., the radiator core 304) through the radiator coolant inlet 301. In the radiator core 304, heat may be transferred from the coolant fluid to the surrounding air, e.g., through the process of convection, and/or by use of fan(s). As air flows over the radiator's fins, it carries away the heat, cooling down the coolant fluid. The cooled-down coolant may then continuously be pumped out of the radiator assembly 109 and circulated in the cooling channel carrying away the heat generated by the fuel cell stack. Air and/or fuel exhaust from the fuel cell stack 101 may enter the radiator exhaust inlet 302 at the radiator assembly 109, be cooled down and exhausted through the radiator assembly 109, or the air exhaust may be to be re-circulated back to the fuel cell stack 101. In this example, the same radiator fan 110 is used for heat exchange of the coolant and air exhaust passing through the radiator assembly 109.

Effective thermal management is crucial for maintaining the optimal operating temperature of a fuel cell system. Operating at the appropriate temperature ensures the efficiency and longevity of the fuel cell components while preventing overheating-related issues. Temperature sensors may be used to detect the temperature of the fuel cell stack, the interior temperature and/or exterior temperature of the fuel cell system. The system controller 116 may be configured to monitor the temperatures and adjust the coolant flow rate and fan speed in order to maintain a consistent operating temperature within a desired range.

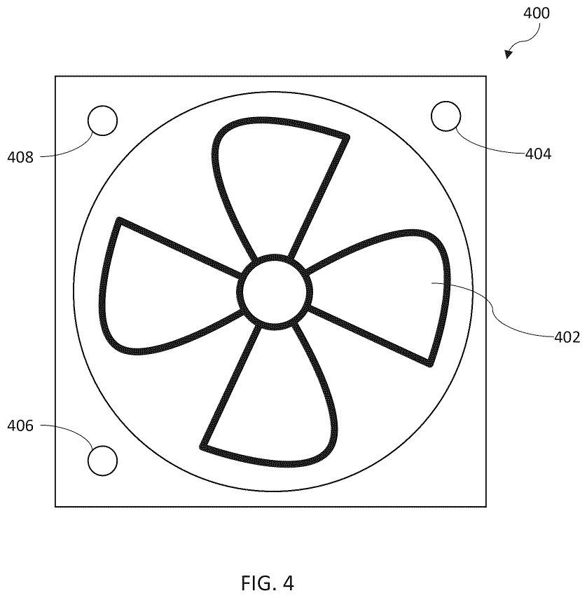

Conventionally, a radiator assembly design generally makes use of one or two fans for the purpose of dispersing heat from the radiator assembly, and the fans may be performed at different rates. Further, conventional radiator assemblies in fuel cell systems are mainly designed for a single purpose, i.e., dissipating heat. FIG. 4 is a diagram of an example radiator assembly 400 used in a fuel cell system according to a conventional technology. FIG. 4 is a front view of the radiator 400. The radiator 400 includes a radiator fan 402, a radiator coolant inlet 404, a radiator coolant outlet 406 and an air exhaust inlet 408. As used herein, the terms of “radiator fan” and “fan” are used interchangeably.

The coolant enters the radiator 400 through the radiator coolant inlet 404, and exits the radiator 400 through the radiator coolant outlet 406. As the coolant flows through the radiator 400, the radiator fan 402 operates at a speed to dissipate the heat of the passing coolant into surrounding air so as to cool the coolant. Warm/hot air and/or fuel exhaust from a fuel cell stack may enter the radiator 400 from the air exhaust inlet 408, and is also cooled down by the fan 402 when passing through the radiator 400.

A radiator fan may be controlled to operate at a speed (spinning speed) ranging from 0% (off) to 10% to 100% of its designed speed. In some cases, due to the mechanical design of circular fans on a rectangular radiator, a radiator fan may only be able to force air through about 50% of the surface area of the radiator fan 402. In practice, the radiator assembly 400 and the fan 402 may need to be oversized to cool the fuel cell system as desired. This leads to wasted space as well as wasted power when the fuel cell system operates at its max cooling capability. These geometric design constraints lead to a fuel cell system having an “available cooling capability” ranging from 5% to 50% with the given radiator size/design. As an example, when the fuel cell system is used in an environment of high temperatures (high ambient temperatures), the radiator (and fan(s)) may further be oversized to avoid the fuel cell system from being overheated, to achieve the necessary cooling capability. As used herein, the cooling capability (or heat rejection capacity) of a radiator is the total amount of energy able to be transferred through the radiator at a given set of air temperature, flow, and coolant temperature and flow conditions. More details about radiator cooling capability is well known to those of ordinary skill in the art and is beyond the scope of the present disclosure.

In the case of low ambient temperatures, however, such designed fuel cell system may not need to operate even at its 5% cooling capability because the low-temperature air around the fuel cell system is more effective at cooling the system. In reality, such a designed fuel cell system, when used at low ambient temperatures, may appear to achieve 10-100% of the designed heat rejection capacity (cooling capability). In practice, this may lead to the radiator fan being turned off for thermal reasons. When this happens, the fuel cell stack exhaust (e.g., air, water vapor, etc.) may condense on the fins of the radiator and collect inside or/outside of the system.

Further, non-reacted hydrogen may be periodically purged from a fuel cell system. During the period of purging hydrogen, the radiator fan is turned on to ensure that the hydrogen is safely discharged. When the period is short, the operation of a large fan during a short period of time is enough to affect the system temperature if the fuel cell system operates at low ambient temperature conditions. As the ambient temperature goes down, more challenges arise for normal system operations.

Thus, the ambient temperatures and the discharge of system exhaust may negatively affect a fuel cell system that has a radiator with a designed cooling capability. The system exhaust may be fuel cell stack exhaust including fuel (e.g., hydrogen), water vapor and air, which may be hot/warm due to the electrochemical reactions at the fuel cell stack. It is desirable that the radiator may be able to adapt to those factors described above. It is also desirable that a fuel cell system may utilize the radiator for more than just cooling of the system coolant loop and air exhaust. For example, it is desirable that the same radiator may also be used for hydrogen purge/discharge, cathode compressed air discharge, and/or water vapor discharge from a fuel cell system, i.e., for discharging the fuel cell stack exhaust, which may be controlled separately from each other and/or controlled separately from the cooling of coolant. However, the conventional radiator design with a single fan or multiple fans designated solely for cooling is inadequate to meet these needs.

Embodiments of the present disclosure provide a fuel cell system including a radiator (or radiator assembly), where radiator fans may be separately controlled to operate based on different parameters of the fuel cell system. The embodiments expand the usage of the radiator in the fuel cell system, incorporate further functions/features into the radiator, improve the efficiency of the radiator and the fuel cell system, and provide flexibility for controlling the radiator of the fuel cell system. As used herein, fuel cell stack exhaust generally refers to exhaust generated by a fuel cell stack, which may include fuel exhaust (e.g., hydrogen exhaust), air exhaust, water vapor exhaust (or moisture exhaust), or any combination thereof.

In some embodiments, a radiator of a fuel cell system, such as the fuel cell system 100, may include the following: a radiator core (which may include radiator fins for heat exchange with surrounding air, and a coolant channel as part of the cooling channel of the fuel cell system for circulating coolant through the radiator), fans, a coolant inlet (e.g., a coolant in-hose), a coolant outlet (e.g., a coolant out-hose), a coolant fill port for filling coolant in the cooling channel (e.g., the radiator coolant fill port 303), a coolant reservoir storing coolant, an inlet of cathode exhaust (e.g., mixture of fuel cell stack air exhaust and water vapor), an inlet of anode purge exhaust (e.g., fuel (e.g., hydrogen) exhaust, which may be mixed with the cathode air exhaust), and/or any combination thereof. The inlet of cathode exhaust and the inlet of anode purge exhaust may be combined as one inlet for the fuel cell stack exhaust, which may include hydrogen, air and water vapor.

The radiator core (e.g., the fins, and the coolant channel) may be implemented similarly as conventionally known in the art. The coolant fill port and the coolant reservoir may be optional. The fans may be an array of fans mounted on one side of the radiator, and the fins may be provided on the other side of the radiator. In some embodiments, an array of smaller fans may be used in the radiator, to cover more of the surface area of the radiator.

In some embodiments, some or all of the fans may be divided into multiple groups, where each group includes one or more fans. The groups may be designated with different tasks (or functions/purposes) and controlled (e.g., turning on, turning off, changing speed, and so on) according to their designated tasks. Example tasks may include cooling coolant, cooling air exhaust, discharging air exhaust, discharging fuel exhaust, discharging water vapor, and other tasks applicable for the radiator of the fuel cell system. Two or more tasks may be combined into one task. There may be various numbers of groups of fans for a radiator. In some embodiment, two groups may share zero, one or more common fans. In some embodiments, the fans may be grouped based on their locations with respect to the exhaust inlets/outlets and the coolant inlets/outlets.

As an example, a first group may be designated for coolant cooling, a second group may be designated for fuel exhaust (e.g., hydrogen) discharge, a third group may be designated for cathode exhaust discharge, and a fourth group may be designated for air exhaust cooling. In this example, the first group may be located close to the coolant inlet and/or coolant outlet. In one embodiment, the second group may be located close to the fuel exhaust port of the fuel cell system, the third group may be close to a moisture (water vapor) discharge port of the fuel cell system, and the fourth group may be close to an air exhaust port of the fuel cell system.

In another embodiment, the fuel exhaust port, the moisture discharge port and the air exhaust port may have corresponding inlets at the radiator, respectively, and the fuel exhaust, moisture discharge and air exhaust may reach the radiator through the corresponding inlets over corresponding channels or paths (e.g., tubes, pipes, hoses) to be discharged or cooled down by use of the radiator/fans. The channels or paths may be composed of tubes, pipes, or in other applicable structures. In this case, the second, third and fourth groups may be close to their corresponding inlets at the radiator.

As another example, a first group may be designated for coolant cooling, and a second group may be designated for discharging and cooling fuel cell stack exhaust (e.g., air exhaust, moisture and fuel exhaust). In this example, the first group may be close to the coolant inlet and/or coolant outlet, and the second group may be close to a fuel cell stack exhaust inlet at the radiator. The fuel cell stack exhaust enters the radiator through the fuel cell stack exhaust inlet, and is discharged and/or cooled down by the radiator. The cooled air may be circulated back to the fuel cell stack and reused. The fans may be grouped for designated tasks in various ways applicable without departing from the principle and spirit of the present disclosure.

While a specific group is designated for a specific task, it may also be turned on or off when needed for another task. As an example, the fuel cell system may turn on the first group and the second group simultaneously to avoid system overheat. A radiator may be configured such that a fan of a group associated with a task may be controlled to be used for any other task.

Configuration of the fans of the radiator, e.g., the number of the fans, sizes of the fans, layout of the fans, grouping of the fans, and so on, may be designed based on various factors, such as specific applications/designs of the fuel cell system, size of the radiator, locations of the fuel cell stack and its exhaust port(s), location of the radiator, location of the cooling channel of the fuel cell system, and so on, which will be apparent to those of ordinary skill in the art under the principle and spirit of the present disclosure. The fans may be mounted on the radiator according to a specific pattern, e.g., evenly spread on the surface of the radiator.

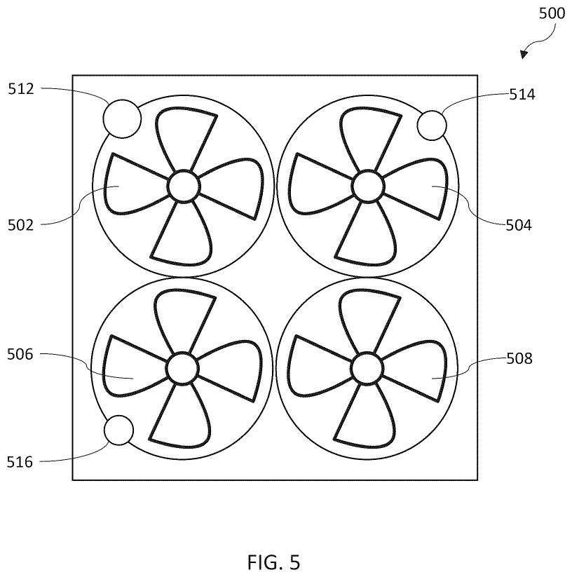

FIG. 5 is a diagram of an example radiator 500 of a fuel cell system according to embodiments of the present disclosure. The radiator 500 may be used in the fuel cell system 100, e.g., replacing the radiator assembly 109. FIG. 5 is a front view of the radiator 500, e.g., viewed from the interior of the fuel cell system 100.

The radiator 500 includes an array of fans including fans 502, 504, 506 and 508, a fuel cell stack exhaust inlet 512 through which fuel cell stack exhaust passes the radiator 500 and dissipates in the air, a coolant inlet 514 and a coolant outlet 516 through which coolant enters and exits the radiator 500 respectively. In this example, the array of fans includes four fans arranged as shown in FIG. 5, and the four fans are identical. Other numbers of fans may also be applicable for the array of fans. These fans may be evenly distributed on the radiator surface, distributed according to a pattern, or distributed based on their tasks. The array of fans may have the same or different sizes and speeds, e.g., depending on applications and designs. In this example, the fan 502 may form a first group, and the fans 504 and 506 may form a second group.

In this example, the fuel cell stack exhaust inlet 512 is closer to the sweeping area of the fan 502 than the coolant inlet 514 and the coolant outlet 516, and the fan 502 is designated for discharging the fuel cell stack exhaust of the fuel cell system. With the help of the airflow generated by the fan 502, the air, water vapor and hydrogen stream exhaust may be discharged out of the fuel cell system more efficiently, which increases the exhaust discharge capability of the fuel cell system. The fan 502, while designated for exhaust discharge, may at the same time help cool the air exhaust. The coolant inlet 514 and the coolant outlet 516 are respectively closer to the sweeping areas of the fans 504 and 506 than the fuel cell stack exhaust inlet 512, and are designated for cooling the coolant circulated inside the radiator 500 through the coolant inlet 514 and the coolant outlet 516, so as to cool the fuel cell system.

The fan 508 may not be grouped, or may form a third group designated for another specific task (e.g., for cooling air exhaust), or may be grouped with the first group or the second group. As an example, the fan 508 may not be grouped and may be used as a back-up fan of the radiator 500, which provides flexibility for the operation of the radiator 500. As an example, when detecting that one fan of the first group or the second group fails to operate, the system controller may control the fan 508 to operate in place of the fan in failure. While keeping the radiator 500 to continue to work, the system controller may also sent out notification notifying the failure of the fan. or when additional cooling/discharging power is needed. As another example, the system controller may detect that the fuel cell stack exhaust of the fuel cell system is more than a regular level or a threshold level, the system controller may also turn on the fan 508, in addition to turning on the fan 502, in order to provide sufficient discharging power. Similarly, the fan 508 may also be turned on together with the fans 504 and 508 if needed.

By use of the array of fans, the surface area of the radiator 500 may be made better use of. As an example, with the layout of the array of fans as shown in FIG. 5, 80% of the radiator surface area is usable. This design may lead to an “available cooling capacity” of the radiator being from 2% to 80% of the radiator design size. Thus, the radiator 500 itself may be designed to be about 30% smaller than a conventional radiator.

Each of the fans or the groups may be controlled separately to operate (to turn on/off). In some embodiments, the fan(s) to be turned on/off, the spinning speed(s) of the fan(s), and the on-time (or operation time) of the fan(s) may be determined, and the corresponding fan(s) are controller to operate accordingly. In some embodiments, the spinning speed(s) and the on-time may also be pre-configured and fixed, and be configurable. In an example, the spinning speed of each fan may be controlled to vary in multiple levels, e.g., the speed may vary from 0 (i.e. being turned off) to 10%, 30%, . . . , to 100%. The spinning speed levels of each fan may be pre-configured. Fans in the same group may be configured with the same spinning speed levels. Fans in different group may be configured with the same or different spinning speed levels.

In some embodiments, the control of the groups of fans may be based on various task-related parameters. Each group designated with a task may be associated with parameter(s) corresponding to the task. The fuel cell system may be configured to monitor the parameter(s) associated with each group, and detect whether the parameter(s) satisfy a condition/criteria corresponding to the task of each group. When the condition/criteria is satisfied, the fuel cell system, e.g., the system controller 116 in FIG. 1, may control the operation of the corresponding group of fans accordingly, e.g., turning off fan(s) of a group, turning on fan(s) of a group at a spinning speed, adjusting the spinning speed(s), turning on fan(s) of a group at a spinning speed for a certain period of time, and so on.

Table 1 below shows example tasks and their associated parameter(s), which may be monitored for controlling the corresponding group of fans. Table 1 merely shows an example for illustrative purposes, and the tasks and associated parameters are limited hereto. These parameters may be detected/measured utilizing corresponding sensors, such as thermometers, timers, gas concentration sensors/meters, moisture meters, and so on.

TABLE 1

| No. | Task | Parameter(s) |
|---|---|---|
| 1 | Cooling coolant | Interior temperature, |
| | | ambient temperature, |
| | | and/or coolant temperature |
| 2 | Cooling air exhaust | Interior temperature, and/or ambient |
| | | temperature |
| 3 | Discharging air exhaust | Oxygen concentration |
| 4 | Discharging fuel | Fuel concentration, and/or fuel exhaust |
| | exhaust | purge periodicity |
| 5 | Discharging water | Moisture level |
| | vapor (moisture) | |

In some embodiments, the conditions/criteria may be defined/configured for the fuel cell system to determine the group(s)/fan(s) to be turned on/off, the on-time of each fan, and/or the spinning speed of each fan, based on the related parameters. The spinning speed of the fans and the on-time may also be pre-configured and fixed, and configurable. The conditions/criteria may be pre-defined and configurable based on the related parameters, and may vary based on particular applications of a fuel cell system, the environment that a fuel cell system is to be used, and various other applicable factors. A fuel cell system (e.g., with use of a system controller such as the system controller 116) may monitor, e.g., continuously or periodically, task-related parameters, and detect whether one or more criteria are satisfied (one or more conditions are met) by the task-related parameters. The system controller may receive/collect, continuously or periodically, measurements/data of the task-related parameters being monitored, determine whether one or more criteria are satisfied, and based thereon, generate control signals to control on/off of fan(s)/group(s). In some embodiments, the control signals may include information of the duration of the on-time of the fan(s), and/or rotating speed(s) of the fan(s). The fan(s) is/are configured to run for the duration of the on-time and then stop. In some embodiments, the on-time of the fan(s) may be a fixed value and configured for the fan(s). In some embodiments, the on-time of the fan(s) may ends when the criteria is no long satisfied. In this case, the fan(s) may be controlled to turn off when determining that the criteria is not satisfied.

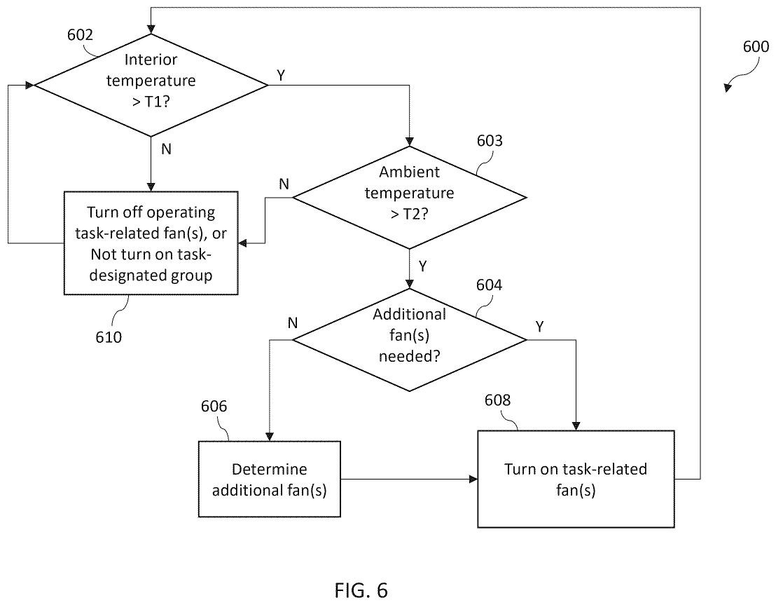

FIG. 6 is a flowchart of an example method 600 of controlling a radiator for cooling according to embodiments of the present disclosure. The method 600 provides example operations performed at a fuel cell system (e.g., by use of a system controller), for example, at the fuel cell system 100 by use of the system controller 116 as described with respect to FIG. 1 and FIG. 2. The radiator may be any radiator described in the embodiments of the present disclosure (e.g., the radiator 500), and includes fans designated for one or more tasks in the fuel cell system. In this example, the radiator may include a group of fans designated for cooling coolant or air (referred to “task-designated group”).

The fuel cell system may monitor its interior temperature (e.g., by use of a thermometer), and detect whether the interior temperature exceeds a first temperature threshold T1 (step 602). The interior temperature may be a temperature measured at a position in the fuel cell system (e.g., inside a housing of the fuel cell system) or an average temperature of temperatures measured at multiple positions in the fuel cell system.

In some embodiments, the fuel cell system may also monitor its ambient temperature for cooling control. The ambient temperature may be a temperature measured at a position outside the fuel cell system (e.g., outside the housing of the fuel cell system), or an average temperature of temperatures measured at multiple positions outside the fuel cell system. In an example, when the interior temperature exceeds the first temperature threshold T1, the fuel cell system may detect whether the ambient temperature exceeds a second temperature threshold T2 (step 603). The step 603 may be performed before, after, or at the same time as the step 602. The steps 602 and 603 may be combined into one step.

When detecting that the ambient temperature exceeds the second temperature threshold T2, the fuel cell system may determine whether additional fan(s) may be needed for cooling (step 604). While the task-designated group is designated for the task of cooling, situation may arise where the task-designated group alone is not sufficient to fulfill the cooling task as desired (e.g., lowering the interior temperature to desired temperature within a desired time duration). As an example, one or more fans of the task-designated group may not operate properly or may not work, in which case, other fan(s) may be needed in place of the one or more fans having problem. As another example, the interior temperature may exceed the first temperature threshold T1 by a third temperature threshold T3, or the ambient temperature may exceed the second temperature threshold T2 by a fourth temperature threshold T4, and the fuel cell system may need more fan(s) to work together in order to quickly lower the interior temperature to a desired level for the fuel cell system to operate normally. The thresholds T1, T2, T3 and T4 may be determined based on historical data, such as interior temperatures, ambient temperatures, cooling performance, radiator performance, and so on.

When determining that additional fan(s) are needed for cooling, the fuel cell system may determine the additional fan(s) (step 606). The additional fan(s) may be selected from all other fans of the radiator not belonging to the task-designated group and not operating. The fuel cell system may also determine the number of the additional fan(s) to be selected. Taking the radiator 500 as an example, the fans 504 and 506 form the task-designated group for cooling. The fan 502, the fan 508, or both fans 502 and 508 may be selected as the additional fans. As used herein, fan(s) that is/are determined to be used for a task may be referred to as “task-related fan(s).” The task-related fan(s) may only include the task-designated group, or include a combination of the task-designated group and the additional fan(s) determined for the specific task.

After determining the additional fan(s), the fuel cell system may then control (e.g., with use of the system controller) to turn on the task-related fan(s) (step 608). In this case, the task-related fan(s) include the combination of the task-designated group and the additional fan(s) determined. At step 608, the fuel cell system may set the speed and/or on-time of each of the task-related fan(s).

It is possible that there is no fan available to be selected as the additional fan(s). In this case, no additional fan is selected, and the task-related fan(s) only include the task-designated group. The method 600 proceeds to step 608 where the fuel cell system turns on fan(s) of the task-designated group.

When determining that additional fan(s) are not needed for cooling, the method 600 proceeds to the step 608, where the task-related fan(s) only include the task-designated group, and the fuel cell system turns on fan(s) of the task-designated group. After turning on the task-related fan(s) at step 608, the method 600 may go back to step 602 to continue monitor the interior temperature, and the ambient temperature if configured. In some embodiments, if the task-related fan(s) are configured to operate for a fixed duration Tₒₙafter being turned on, the fuel cell system may start performing the step 602 after the fixed duration Tₒₙ after the step 608 is performed. The task-related fan(s) may be controlled to turn off or automatically turn off after the fixed duration Tₒₙ.

When detecting that the interior temperature does not exceed the first temperature threshold T1 (at step 602), the fuel cell system may turn off the task-related fan(s) in operation, or if no task-related fan(s) is in operation for the task, the fuel cell system may determine to not turn on any fan for the task (step 610). When detecting that the interior temperature exceeds the first temperature threshold T1, and that the ambient temperature does not exceed the second temperature threshold T2, the method 600 proceeds to the step 610.

In some embodiments, the step 602 and 603 may be combined into one step. The fuel cell system monitors the interior temperature and the ambient temperature, if the interior temperature and the ambient temperature satisfy the criteria, i.e., the interior temperature exceeds T1 and the ambient temperature exceeds T2, the method 600 proceeds to the step 604. If the interior temperature does not exceed T1 or the ambient temperature does not exceed T2, the method 600 proceeds to the step 610.

The step 603, and/or the steps 604 and 605 may be optional. The fuel cell system may determine whether to turn on/or the task-designated group solely based on the interior temperature. The fuel cell system may not determine whether to use additional fan(s), and merely rely on the task-designated group for the designated task.

In some embodiments, the fuel cell system may be configured to determine whether to turn on one, some or all fans in the task-designated group for cooling purposes. This may be determined based on the interior temperature, the ambient temperature, the cooling capability of the fans, and other applicable factors.

As described above, the fuel cell stack generates hydrogen exhaust (herein referred to as anode exhaust), and air exhaust and water exhaust (collectively referred to herein as cathode exhaust), which need to be discharged. The anode exhaust and the cathode exhaust are collectively referred to as fuel cell stack exhaust. In some embodiments, the fuel cell stack may be provided with separate outlet ports for discharging the anode exhaust and the cathode exhaust, in which case, the radiator may be provided with respective exhaust inlets corresponding to the outlet ports. Channels or passageways may be established such that the anode exhaust and the cathode exhaust pass or enter the radiator through the respective exhaust inlets, and are discharged by the radiator fans. In some embodiments, the radiator may be provided with one exhaust inlet corresponding to the outlet ports, and the anode exhaust and the cathode exhaust pass or enter the radiator through this exhaust inlet. In some embodiments, the fuel cell stack may be provided with one outlet port for discharging both the anode exhaust and the cathode exhaust, and the radiator may be provided with one exhaust inlet corresponding to the outlet port. In some embodiments, when separate outlet ports are provided in the fuel cell stack for discharging the hydrogen exhaust, air exhaust and water exhaust, the radiator may be provided with separate exhaust inlets corresponding to the hydrogen exhaust, air exhaust and water exhaust, or the radiator may be provided with one exhaust inlet corresponding to the hydrogen exhaust, air exhaust and water exhaust. Design of exhaust inlets at the radiator for discharging exhaust may vary depending on the specific applications and design requirements.

In some embodiments, the fuel cell system may be configured to purge/discharge the fuel cell stack exhaust periodically or based on whether specific condition(s)/criteria are met. A group of fans of the radiator may be designated with the task of exhaust discharge, and the group of fans may be controlled to operate to facilitate exhaust discharge.

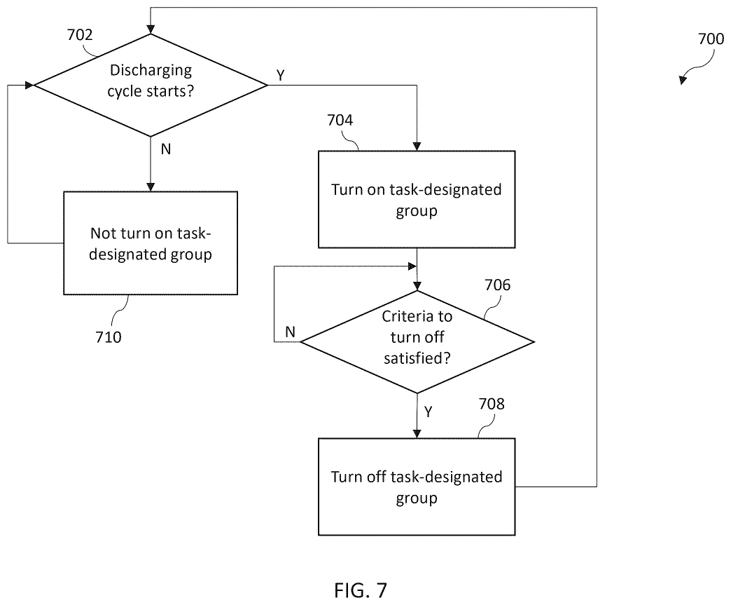

FIG. 7 is a flowchart of an example method 700 of controlling a radiator for exhaust discharge according to embodiments of the present disclosure. In this example, the fuel cell system may be configured to discharge the exhaust periodically, e.g., the fuel cell system may discharge the exhaust in discharging cycles, with each discharging cycle having a length T_{P} (which may also be referred to as a discharging period T_{P}). The radiator may be any radiator described in the embodiments of the present disclosure (e.g., the radiator 500), and includes fans designated for one or more tasks in a fuel cell system. The radiator may include a group of fans designated for exhaust discharge (referred to “task-designated group”). The exhaust to be discharged may include the hydrogen exhaust, the air exhaust, the water exhaust, or any combination thereof.

As shown in FIG. 7, the fuel cell system may detect whether a discharging cycle starts (step 702), e.g., whether a discharging period T_{P} has passed. The fuel cell system (e.g., the system controller) may set a timer (e.g., with a length of T_{P}) for monitoring the exhaust discharging periods. When detecting that the discharging cycle has not started, the fuel cell system may determine to not turn on the corresponding task-designated group (step 710), and goes back to step 702 to continue to monitor for the discharging cycle. When detecting that the discharging cycle starts, the fuel cell system may turn on the corresponding task-designated group of fans for discharging the exhaust (step 704). In some embodiments, the spinning speed and on-time of the task-designated group may be fixed and pre-configured. In some embodiments, the fuel cell system may determine the spinning speed(s) and the on-time of the task-designated group based on specific status of the exhaust, e.g., the concentration of the hydrogen or air exhaust, and/or the moisture level.

The fuel cell system may determine whether a criteria to turn off the task-designated group is satisfied (step 706). If the criteria is satisfied, the fuel cell system controls to turn off the task-designated group (step 708), and goes back to step 702 to monitor for the next discharging cycle. If the criteria is not satisfied at step 706, the fuel cell system continues to monitor status of the criteria (i.e., whether the criteria to turn off is satisfied).

The criteria may be defined based on various parameters related to the exhaust to be discharged or related to the discharging, which may be collectively referred to as parameters associated with discharge of fuel cell stack exhaust. As examples, the parameters may include a concentration of the hydrogen exhaust, a concentration of the air exhaust, a level of moisture, or a time duration ta of exhaust discharging (referred to as a discharging duration). The concentration of the hydrogen exhaust and the concentration of the air exhaust may be measured using a gas concentration sensor or meter, and may be a single measurement or an average of multiple measurements. One or more concentration sensors or meters may be set inside the fuel cell system, e.g., near the fuel cell stack, near the outlet port(s) of the exhaust, and/or near the radiator. The moisture level may be measured using a moisture meter, and may be a single measurement or an average of multiple measurements. One or more moisture meters may be set inside the fuel cell system, e.g., near the fuel cell stack, or near the outlet port(s) of the exhaust, and/or near the radiator. The discharging duration t_{d} may be pre-configured and fixed, and may be configurable. The discharging duration ta indicates how long the discharging lasts for each discharging cycle T_{P}. Table 2 below shows example criteria that may be used to determine whether to turn off the task-designated group. Table 2 shows five example cases, and for each case, Table 2 shows the exhaust to be discharged (where the task-designated group is assigned for discharging the exhaust), and the criteria used to determine whether to turn off the turned-on task-designated group. Other applicable criteria and other parameters may also be used without departing from the spirit and principle of the present disclosure.

TABLE 2

| No. | Exhaust | Criteria to turn off fan(s) |
|---|---|---|
| Case 1 | hydrogen exhaust | Criteria 1: Concentration |
| | | of hydrogen < threshold |
| Case 2 | air exhaust | Criteria 2: Concentration |
| | | of oxygen < threshold |
| Case 3 | water vapor | Criteria 3: Moisture < threshold |
| | | level |
| Case 4 | A combination of two | A combination of two |
| | or more of hydrogen | or all of Criteria 1-3 |
| | exhaust, air exhaust, | corresponding to the |
| | and water exhaust | exhaust in combination |
| Case 5 | hydrogen exhaust, air | Criteria 4: Discharging |
| | exhaust, water, or any | duration ta ends |
| | combination thereof | |

As an example, for case 1, the task-designated group is designated for discharging hydrogen exhaust, and when detecting that Criteria 1 is satisfied at step 706, the fuel cell system controls to turn off the task-designated group. As another example, for case 2, the task-designated group is designated for discharging air exhaust, and when detecting that Criteria 2 is satisfied at step 706, the fuel cell system controls to turn off the task-designated group. As another example, for case 3, the task-designated group is designated for discharging water exhaust, and when detecting that Criteria 3 is satisfied at step 706, the fuel cell system controls to turn off the task-designated group. As another example, for case 4, when the task-designated group is designated for discharging the combination of hydrogen exhaust, air exhaust and water exhaust, and when detecting that Criteria 1-3 are all satisfied at step 706, the fuel cell system controls to turn off the task-designated group. As another example, for case 4, when the task-designated group is designated for discharging the combination of air exhaust and water exhaust, and when detecting that Criteria 2-3 are all satisfied at step 706, the fuel cell system controls to turn off the task-designated group. As another example, for case 5, when the task-designated group is designated for discharging the combination of hydrogen exhaust, air exhaust and water exhaust, and when detecting that Criteria 4 is satisfied at step 706, the fuel cell system controls to turn off the task-designated group.

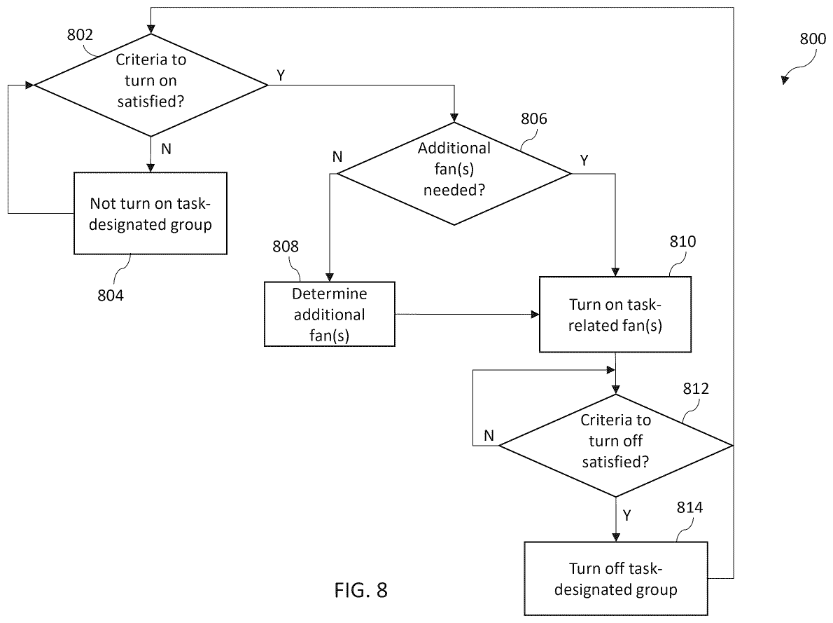

FIG. 8 is a flowchart of another example method 800 of controlling a radiator for exhaust discharge according to embodiments of the present disclosure. In this example, the fuel cell system may be configured to discharge the exhaust when certain conditions or criteria are satisfied. The radiator may be any radiator described in the embodiments of the present disclosure (e.g., the radiator 500), and includes fans designated for one or more tasks in a fuel cell system. The radiator may include a group of fans designated for exhaust discharge (referred to “task-designated group”). The exhaust to be discharged may include the hydrogen exhaust, the air exhaust, the water exhaust, or any combination thereof.

As shown in FIG. 8, the fuel cell system may detect whether a criteria to turn on fans is satisfied (step 802). If the criteria is not satisfied, the fuel cell system determines to not turn on the task-designated group (step 804) and goes back to step 802 to continue to monitor the criteria to turn on fans. If the criteria is satisfied, the fuel cell system proceeds to step 806.

The criteria to turn on fans may be defined based on various parameters associated with discharge of the fuel cell stack exhaust. As examples, the parameters may include a concentration of the hydrogen exhaust, a concentration of the air exhaust, or a moisture level. Table 3 below shows example criteria that may be used to determine whether to turn on fans for the task of exhaust discharge. Table 3 shows four example cases, and for each case, Table 3 shows the exhaust to be discharged (where the task-designated group is assigned for discharging the exhaust), and the criteria used to determine whether to turn on the task-designated group. Criteria 1-8 in Table 2 and Table 3 may be collectively referred to as exhaust discharging criteria.

TABLE 3

| No. | Exhaust | Criteria to turn on fan(s) |
|---|---|---|
| Case 6 | hydrogen | Criteria 5: Concentration of |
| | exhaust | hydrogen > threshold |
| Case 7 | air exhaust | Criteria 6: Concentration of oxygen |
| | | threshold |
| Case 8 | water exhaust | Criteria 7: Moisture > threshold level |
| Case 9 | A combination | A combination of two or all of |
| | of two or more | Criteria 5-7 corresponding to the |
| | of hydrogen | exhaust in combination; or |
| | exhaust, air | Any one of the two |
| | exhaust, and | or all of Criteria 5-7 |
| | water exhaust | corresponding to the exhaust |
| | | in combination |

As an example, for case 6, the task-designated group is designated for discharging hydrogen exhaust, and when detecting that Criteria 5 is satisfied at step 802, the fuel cell system proceeds to step 806. As another example, for case 8, the task-designated group is designated for discharging water exhaust, and when detecting that Criteria 7 is satisfied at step 802, the fuel cell system proceeds to step 806. As another example, for case 9, when the task-designated group is designated for discharging the combination of hydrogen exhaust, air exhaust and water exhaust, and when detecting that Criteria 6-8 are all satisfied at step 802, or when detecting that any one of Criteria 6-8 is satisfied, the fuel cell system proceeds to step 806. As another example, for case 9, when the task-designated group is designated for discharging the combination of air exhaust and water exhaust, and when detecting that Criteria 7-8 are satisfied at step 802, or when detecting that any one of Criteria 7-8 is satisfied, the fuel cell system proceeds to step 806.

When detecting that the criteria to turn on fans is satisfied at step 802, the fuel cell system may determine whether additional fan(s) may be needed for exhaust discharge (step 806). While the task-designated group is designated for the task of discharging exhaust, situation may arise where the task-designated group alone is not sufficient to fulfill the exhaust discharging task as desired (e.g., reducing the concentration of hydrogen/air exhaust within a desired time duration, or reducing the moisture level within a desired time duration). For example, one or more fans of the task-designated group may not operate properly or may not work, or the hydrogen/air exhaust concentration or the moisture level falls in a range that requires additional fan(s).

Steps 808 and 810 are similar to the steps 606 and 608 in FIG. 6. When determining that additional fan(s) are needed for exhaust discharge, the fuel cell system may determine the additional fan(s) (step 808). The additional fan(s) may be selected from other fans of the radiator not belonging to the task-designated group and not operating. The fuel cell system may also determine the number of the additional fan(s) to be selected. Taking the radiator 500 as an example, the fan 502 forms the task-designated group for exhaust discharge, the fans 504 and 506 forms a task-designated group for cooling, and the fan 508 is a back-up fan. One or more of the fans 504, 506 and 508 may be selected as the additional fan(s). It is possible that there is no fan available to be selected as the additional fan(s). For example, the fans 504, 506 and 508 have already been turned on for another task. In this case, no additional fan is selected.

As noted previously, fan(s) that is/are determined/selected to be used for a task may be referred to as “task-related fan(s).” The task-related fan(s) may only include the task-designated group when no additional fan(s) is needed or available, or include a combination of the task-designated group and the additional fan(s) determined for the specific task.

After determining the additional fan(s), the fuel cell system may then control (e.g., with use of the system controller) to turn on the task-related fan(s) (step 810). The task-related fan(s) may include a combination of the task-designated group and the additional fan(s) selected, or only the task-designated group when no additional fan is available. When determining that no additional fan(s) is needed for exhaust discharge, the method 800 proceeds to the step 810. The task-related fan(s) includes only the task-designated group. At step 810, the fuel cell system may set the speed and/or on-time of each of the task-related fan(s).

Steps 812, 814 are similar to the steps 706 and 708. After turning on the task-related fan(s), the fuel cell system may determine whether a criteria to turn off the task-related fan(s) is satisfied (step 812). If the criteria to turn off is satisfied, the fuel cell system controls to turn off the task-related fan(s) (step 814), and goes back to the step 802 to continue to monitor whether the criteria for turning on fans is satisfied. If the criteria to turn off is not satisfied at step 812, the fuel cell system continues to monitor the status of the criteria (i.e., whether the criteria to turn off is satisfied). For detailed description about the steps 812 and 814, please refer to the description with respect to the steps 706 and 708. The discharging duration ta may be a time duration configured for discharging exhaust. Table 2 may be used as example criteria to turn off fans.

The steps 806 and 808 may be optional. That is, the fuel cell system may be configured to only control on/off of a task-designated group of fans for a task associated with the task-designated group, without considering whether to use an additional fan. In this case, the task-related fan(s) includes only the task-designated group. The steps 812 and 814 may be optional, e.g., the steps 812 and 814 may be removed when the fans are configured to turn off automatically after a fixed period of time.

In some embodiments, when detecting that the ambient temperature is below a threshold, the fuel cell system (the system controller) may be configured to control a group/fan(s) designated for discharge air and water vapor exhaust to operate continuously for a period of time, to help push air/water vapor out of the fuel cell system. When the fuel cell system is operating in an environment having a low ambient temperature, this enables the fuel cell system to discharge the fuel cell stack air/water exhaust streams such that the moisture is not condensed out of the fuel cell system on the face of the radiator. This also facilitates utilization the extremely low heat rejection required at cold ambient conditions, e.g., when the fuel cell system is operating in a freezer/cooler.

Embodiment methods provided in the present disclosure, e.g., the methods 600, 700 and 800, each provide example operations that may be performed at a fuel cell system (e.g., by use of a system controller), for example, at the fuel cell system 100 by use of the system controller 116 as described with respect to FIG. 1 and FIG. 2. Two or more of the methods 600, 700 and 800 may be performed simultaneously at the fuel cell system. The fuel cell system monitors multiple parameters to determine whether to turn on/off task-designated groups/task-related fan(s). The system controller may be configured to receive data of the parameters associated with exhaust discharge (e.g., densities, moisture levels, time durations, etc.) and data associated with cooling (e.g., interior temperatures, ambient temperatures), and to control operations of groups of fans with designated tasks.

Taking the radiator 500 as an example, where the fan 502 is a first group designated for discharge of fuel cell stack exhaust including hydrogen, air and water exhaust, the fans 504 and 506 form a second group designated for cooling, and the fan 508 is a back-up fan. The system controller may perform the method 700 or 800 to control operation of the first group (the fan 502), and may perform the method 600 to control operation of the second group (fans 504, 506). The fan 508 may be controller to work with the first group or the second group. Control for the two groups may be performed in parallel, and separately from each other. The control for the two groups may be performed at the same time or at different time.

Taking the radiator 500 as another example, where the fan 502 is a first group designated for discharge of fuel cell stack exhaust including air and water exhaust, the fans 504 and 506 form a second group designated for cooling, and the fan 508 is a third group designated for discharge of fuel cell stack exhaust including hydrogen exhaust. The system controller may perform the method 700 or 800 to control operation of the first group (the fan 502), may perform the method 600 to control operation of the second group (fans 504, 506), and may perform the method 700 or 800 to control operation of the third group (the fan 508). Control for the three groups may be performed in parallel, and separately from one another. The control for the three groups may be performed at the same time or at different time.

Those of ordinary skill in the art would recognize that various embodiments, alternatives and modifications may be made for designating the radiators fans with different tasks, for defining criteria to control operations of the fans, and for controlling operations of the fans, without departing from the spirit and principle of the present disclosure.

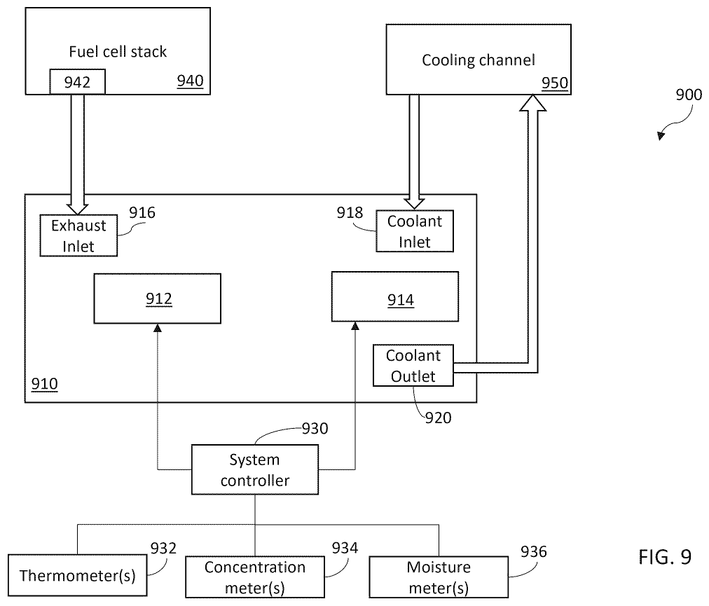

FIG. 9 is a block diagram of an example fuel cell system 900 according to embodiments of present disclosure. The fuel cell system 900 may include other components of the fuel cell system 100 as shown and described with respect to FIG. 1 and FIG. 2. The fuel cell system 900 may include a radiator 910, a system controller 930, a fuel cell stack 940, and a cooling channel 950.

The radiator 910 is configured to cool the fuel cell system 900, and to discharge exhaust of the fuel cell stack 940 as described in the embodiments above. The radiator 910 includes fans that are divided into a first group of fans (912) and a second group of fans (914). The first group 912 is designated for discharging fuel cell stack exhaust, and the second group 914 is designated for cooling the fuel cell system. The fuel cell stack exhaust includes a combination of fuel (hydrogen) exhaust, air exhaust, and water vapor exhaust. The radiator 910 further includes an exhaust inlet 916 through which the fuel cell stack exhaust passes or enters the radiator 910. The first group 912 is closer to the exhaust inlet 916 than the second group 914. The exhaust inlet 916 is in communication with the fuel cell stack 940 such that the fuel cell stack exhaust is purged out from the fuel cell stack 940 (e.g., through a exhaust outlet port 942 of the fuel cell stack 940) and flows to the radiator 910 through the exhaust inlet 916 of the radiator 910. A channel or passageway (e.g., using pipes, hoses or tubing) may be established between the exhaust outlet port 942 of the fuel cell stack 940 and the exhaust inlet 916 of the radiator 910.

The radiator 910 also includes a coolant inlet 918 through which coolant enters the radiator 910 from the coolant channel 950, and a coolant outlet 920 through which the coolant exists the radiator 910 and flows to the coolant channel 950, thereby forming a cooling loop passing through the radiator 910. The coolant circulates in the cooling loop. The cooling channel 950 may be around the fuel cell stack 940, e.g., the cooling channel 950 may pass through each fuel cell of the fuel cell stack 940. The second group 914 is closer to the coolant inlet 918 and the coolant outlet 920 than the first group 912.

The system controller 930 may be similar to the system controller 116 as described with respect to FIG. 1 and FIG. 2. The system controller 930 is coupled to the first group 912 and the second group 914, and configured to control operations of the first group 912 and the second group 914. For example, the system controller 930 may perform the method 700 or the method 800 to control the operation (e.g., on/off, speed, on-time, and so on) of the first group 912, and perform the method 600 to control the operation (e.g., on/off, speed, on-time, and so on) of the second group 914. The system controller 930 may send control signals to the fans of the radiator 910 controlling the operations of the first group 912 and the second group 914. The system controller 930 may also be configured to monitor the status of the fans of the radiator 910, e.g., whether each fan can work and can work properly, or whether the speed and on-time of any fan is controllable as designed.

The system controller 930 is also coupled to one or more sensors, such as thermometer(s) 932, concentration meter(s) 934, moisture meter(s) 936, and so on. The system controller 930 is configured to receive measurements from the sensors and utilize the measurements to control operations of the radiator fans as described above. The system controller 930 may also be configured to monitor whether the sensors are working normally.

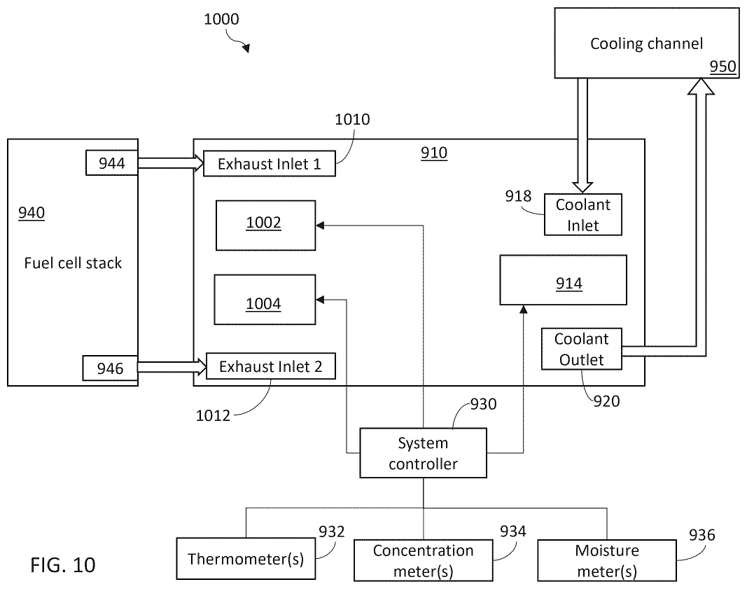

FIG. 10 is a block diagram of another example fuel cell system 1000 according to embodiments of present disclosure. The fuel cell system 1000 is similar to the fuel cell system 900 except that the radiator 910 of the fuel cell system 1000 includes three groups of fans designated for different tasks. The differences of the fuel cell system 1000 from the fuel cell system 900 are further described in the following.

The radiator 910 of the fuel cell system 1000 in FIG. 10 includes fans that are divided into three groups, i.e., a first group of fans (1002), a second group of fans (914), and a third group of fans (1004). The first group 1002 is designated for discharging first fuel cell stack exhaust, the second group 914 is designated for cooling, and second group 1004 is designated for discharging second fuel cell stack exhaust. In one example, the first fuel cell stack exhaust may include a combination of air exhaust and water vapor exhaust, and the second fuel cell stack exhaust may include fuel (hydrogen) exhaust. In another example, the first fuel cell stack exhaust may include a combination of air exhaust and fuel (hydrogen) exhaust, and the second fuel cell stack exhaust may include water vapor exhaust.

The radiator 910 further includes an exhaust inlet 1 (1010) through which the first fuel cell stack exhaust passes or enters the radiator 910, and an exhaust inlet 2 (1012) through which the second fuel cell stack exhaust passes or enters the radiator 910. The first group 1002 may be closer to the exhaust inlet 1010 than other groups. The third group 1004 may be closer to the exhaust inlet 1012 than other groups. The second group 914 may be closer to the coolant inlet 918 and the coolant outlet 920 than other groups.

The exhaust inlet 1010 is in communication with the fuel cell stack 940 such that the first fuel cell stack exhaust is purged out from the fuel cell stack 940 (e.g., through an exhaust outlet port 944 of the fuel cell stack 940) and flows to the radiator 910 through the exhaust inlet 1010 of the radiator 910. A channel or passageway may be established between the exhaust outlet port 944 of the fuel cell stack 940 and the exhaust inlet 1010 of the radiator 910.

The exhaust inlet 1012 is in communication with the fuel cell stack 940 such that the second fuel cell stack exhaust is purged out from the fuel cell stack 940 (e.g., through an exhaust outlet port 946 of the fuel cell stack 940) and flows to the radiator 910 through the exhaust inlet 1012 of the radiator 910. A channel or passageway may be established between the exhaust outlet port 946 of the fuel cell stack 940 and the exhaust inlet 1012 of the radiator 910.

The system controller 930 is coupled to the first group 1002, the second group 914 and the third group 1004, and configured to control operations of the first group 912, the second group 914 and the third group 1004. For example, the system controller 930 may perform the method 700 or the method 800 to control the operation (e.g., on/off, speed, on-time, and so on) of the first group 1002 or the third group 1004, and perform the method 600 to control the operation (e.g., on/off, speed, on-time, and so on) of the second group 914. The system controller 930 may send control signals to the fans of the radiator 910 controlling the operations of the first group 912, the second group 914 and the third group 1004. The system controller 930 may also be configured to monitor the status of the fans of the radiator 910, e.g., whether each fan can work and can work properly, or whether the speed and on-time of any fan is controllable as designed.

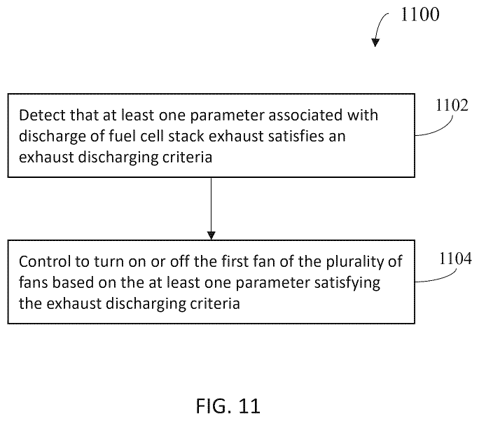

FIG. 11 is a flowchart of a method 1100 according to embodiments of the present disclosure. The method 1100 may be operative at a controller of a fuel cell system (e.g., the system controller 116 in FIG. 1 and FIG. 2), which includes a radiator having a plurality of fans, and the plurality of fans includes a first fan configured to operate for exhaust discharging and a second fan configured to operate for cooling. At step 1102, the controller detects that at least one parameter associated with discharge of fuel cell stack exhaust of the fuel cell system satisfies an exhaust discharging criteria. At step 1104, the controller controls to turn on or off the first fan of the plurality of fans based on the at least one parameter satisfying the exhaust discharging criteria.

In some embodiments, a radiator of a fuel cell system is provided, which includes plurality of fans mounted over a surface of the radiator, a first fan of the plurality of fans being located close to a fuel cell stack exhaust outlet of the fuel cell system, a second fan of the plurality of fans being located close to a coolant inlet of the fuel cell system, and a third fan of the plurality of fans being located close to a coolant outlet of the fuel cell system. The first fan is controllable based on the fuel cell stack exhaust and discharging of the fuel cell exhaust, and the second fan and the third fan are controllable based on at least an interior temperature of the fuel cell system and an exterior temperature of the fuel cell system.

In some embodiments, a method is provided that includes: detecting that a period for discharging a fuel cell stack exhaust of a fuel cell system starts; and turning on a first group of fans of a radiator of the fuel cell system, the first group of fans comprising one or more fans, and the first group of fans being located close to a fuel cell stack exhaust outlet of the fuel cell system.

Embodiments of the present disclosure utilize the airflow generated by the radiator fans to provide not only cooling to the fuel cell system but also discharging of exhaust from the fuel cell system. The embodiments methods utilize the radiator fans more efficiently and improves the efficiency of the radiator in the fuel cell system, which further improves the performance of the fuel cell system. Embodiments of the present disclosure may be applied in fuel cell systems including a liquid cooling system which uses a liquid cooling loop to regulate the temperature of the components of the fuel cell systems.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A radiator of a fuel cell system, comprising:
an exhaust inlet through which fuel cell stack exhaust of the fuel cell system passes through the radiator, wherein the exhaust inlet is disposed on a surface of the radiator;
a first fan mounted on the surface of the radiator, wherein operation of the first fan is controllable based on at least one parameter associated with discharge of the fuel cell stack exhaust; and
a second fan mounted on the surface of the radiator, wherein operation of the second fan is controllable based on at least a temperature of the fuel cell system.

2. The radiator of claim 1, wherein the first fan is closer to the exhaust inlet than the second fan.

3. The radiator of claim 1, further comprising:
a third fan mounted on the surface of the radiator, wherein operation of the third fan is controllable based on the temperature of the fuel cell system.

4. The radiator of claim 3, further comprising:
a coolant inlet and a coolant outlet disposed on the surface of the radiator, wherein the second fan is close to the coolant inlet, and the third fan is close to the coolant outlet.

5. The radiator of claim 3, wherein the operation of the second fan and the operation of the third fan are controllable based on an interior temperature and an ambient temperature of the fuel cell system.

6. The radiator of claim 1, wherein,
the fuel cell stack exhaust comprises fuel exhaust; and
the operation of the first fan is controllable based on the at least one parameter associated with the discharge of the fuel cell stack exhaust comprises:
the first fan is controllable to be turned on or off when a concentration of the fuel exhaust satisfies a criteria.

7. The radiator of claim 1, wherein,
the fuel cell stack exhaust comprises air exhaust; and
the operation of the first fan is controllable based on the at least one parameter associated with the discharge of the fuel cell stack exhaust comprises:
the first fan is controllable to be turned on or off when a concentration of the air exhaust satisfies a criteria.

8. The radiator of claim 1, wherein,
the fuel cell stack exhaust comprises water exhaust; and
the operation of the first fan is controllable based on the at least one parameter associated with the discharge of the fuel cell stack exhaust comprises:
the first fan is controllable to be turned on or off when a moisture level of the water exhaust satisfies a criteria.

9. The radiator of claim 1, wherein the operation of the first fan is controllable based on the at least one parameter associated with the discharge of the fuel cell stack exhaust comprises:
the first fan is controllable to be turned on when an exhaust discharging cycle of the fuel cell system starts; or
the first fan is controllable to be turned off when an exhaust discharging duration ends.

10. A fuel cell system comprising:
a radiator comprising:
an exhaust inlet through which fuel cell stack exhaust of the fuel cell system passes through the radiator, wherein the exhaust inlet is disposed on a surface of the radiator; and
a first fan and a second fan mounted on the surface of the radiator, wherein the first fan is configured to operate for discharge of the fuel cell stack exhaust, and the second fan is configured to operate for cooling of the fuel cell system; and
a controller coupled to the first fan and the second fan, wherein the controller is configured to:
control operation of the first fan based on at least one parameter associated with the discharge of the fuel cell stack exhaust; and
control operation of the second fan based on at least a temperature of the fuel cell system.

11. The fuel cell system of claim 10, further comprising:
a third fan mounted on the surface of the radiator, and configured for cooling of the fuel cell system;
a coolant inlet and a coolant outlet disposed on the surface of the radiator, wherein the second fan is close to the coolant inlet, and the third fan is close to the coolant outlet.

12. The fuel cell system of claim 10, wherein,
the fuel cell stack exhaust comprises fuel exhaust or air exhaust of the fuel cell system; and
the controller is configured to:
turn on or off the first fan when a concentration of the fuel exhaust or the air exhaust satisfies a criteria.

13. The fuel cell system of claim 10, wherein,
the fuel cell stack exhaust comprises water exhaust; and
the controller is configured to:
turn on or off the first fan when a moisture level of the water exhaust satisfies a criteria.

14. The fuel cell system of claim 10, wherein the controller is further configured to:
turn on the first fan when an exhaust discharging cycle of the fuel cell system starts; or
turn off the first fan when an exhaust discharging duration ends.

15. A method comprising:
detecting, at a controller of a fuel cell system, that at least one parameter associated with discharge of fuel cell stack exhaust of the fuel cell system satisfies an exhaust discharging criteria, wherein the fuel cell system comprises a radiator having a plurality of fans, and the plurality of fans comprises a first fan configured to operate for exhaust discharging and a second fan configured to operate for cooling; and
controlling, by the controller of the fuel cell system, to turn on or off the first fan of the plurality of fans.

16. The method of claim 15, further comprising:
detecting, at the controller of the fuel cell system, that at least a temperature of the fuel cell system satisfies a cooling criteria; and
controlling, by the controller of the fuel cell system, to turn on or off the second fan of the plurality of fans.

17. The method of claim 15, wherein,
the fuel cell stack exhaust comprises fuel exhaust or air exhaust; and
controlling to turn on or off the first fan comprises:
controlling to turn on or off the first fan when a concentration of the fuel exhaust or the air exhaust satisfies the exhaust discharging criteria.

18. The method of claim 15, wherein,
the fuel cell stack exhaust comprises water exhaust; and
controlling to turn on or off the first fan comprises:
controlling to turn on or off the first fan when a moisture level of the water exhaust satisfies the exhaust discharging criteria.

19. The method of claim 15, wherein controlling to turn on or off the first fan comprises:
controlling to turn on the first fan when an exhaust discharging cycle of the fuel cell system starts; or
controlling to turn off the first fan when an exhaust discharging duration ends.

20. The method of claim 15, further comprising:
determining a third fan of the plurality of fans when detecting that the at least one parameter satisfies the exhaust discharging criteria; and
controlling to turn on or off the first fan comprises:
controlling, by the controller of the fuel cell system, to turn on the first fan and the third fan.
